(19) United States
(12) Patent Application Publication
(10) Pub. No.: US 2012/0256836 A1
(43) Pub. Date: Oct. 11, 2012

(54) APPARATUS: THE HAND-HELD PISTOL GRIP, DUAL FUNCTIONALITY, KEYBOARD-MOUSE HYBRID EMULATOR USING THE USB, OR PS/2 OR WIRELESS CONNECTION TO THE HOST COMPUTER, AND DESIGNED FOR THE ONE-HANDED OPERATION

(76) Inventor: Ilia Lazar Rudinsky, Brooklyn, NY (US)

(21) Appl. No.: 13/107,944

(22) Filed: May 15, 2011

Related U.S. Application Data
(60) Provisional application No. 61/472,733, filed on Apr. 7, 2011.

(51) Int. Cl. G09G 5/08

(52) U.S. Cl. 345/163

(57) ABSTRACT

A method, apparatus, and article of manufacture are provided to support user communication to the host computer. The apparatus is a hand-held computer peripheral input device, which combines within itself functionalities of two input devices—the keyboard and the mouse—and is an emulator of both the keyboard and the mouse in one device.

### CROSS REFERENCE TO RELATED APPLICATIONS

The present application is a non-provisional utility patent application claiming the benefit of U.S. Provisional Patent Application Ser. No. 61/472,733, filed on Apr. 7, 2011 and titled “The Apparatus: The hand-held pistol-grip, dual functionality, keyboard-mouse hybrid emulator using the USB, PS/2 or wireless connection to the host computer, designed specifically for the one-handed operation,” now pending, which is hereby incorporated by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Technical Field

This invention relates to a portable electronic apparatus, a computer peripheral input device. More specifically, the invention relates to an emulation of multiple input devices combined in one hand-held device and conversion of actuation of the device into computer commands.

2. Description of the Prior Art

A computer is a programmable machine that responds to a specific set of instructions in a well-defined manner and executes a pre-recorded list of instructions, also known as a program. Modern computers are electronic and digital that employs hardware components to support the list of instructions. Hardware components include, but are not limited to, processors, memory, storage, input devices, output devices, etc. As noted above, programs are employed to manipulate data, send messages to an external device, etc.

Computers have evolved over time from a large stand-up computer requiring punch cards, to personal desktop computer, portable laptop computer, personal digital assistants, etc. Regardless of the form of the computer, each computer requires input in some form from an input device. Examples of an input device include a keyboard, a mouse, a trackball, etc.

With the advancement of the computer technology, computers have been decreasing in size, thereby making them more portable. However, the portability of the computer itself does not commonly accommodate the convenient input of data. Most portable computers are not accompanied with the comfortable full size QWERTY keyboard and mouse, as this would eliminate the benefits of the portability. Therefore, there is always a need for the small sized portable input hand-held apparatus, which accommodates the functionality of multiple ubiquitous input devices within itself, such as the keyboard and mouse, for example. Besides being small sized and portable, the Apparatus described herein offers the additional benefit of being able to be used also with any size computers, provided they allow for the use of the regular keyboard and mouse.

### BRIEF SUMMARY OF THE INVENTION

This invention comprises a device, method, and article of manufacture for the user to input commands into the computer, i.e. from the computer industry standpoint the invention can be further characterized as a computer peripheral input device. The features and advantages of this invention will become apparent from the following detailed description of the preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a functional electronic block diagram of the apparatus, showing all the electronic programmable and non-programmable functional blocks that comprise the electronic part of the apparatus with the three USB channels and the programmable interface.

FIG. 2 is a functional electronic block diagram of a simplified embodiment of the apparatus, showing all the electronic programmable and non-programmable functional blocks that comprise the electronic part of such simplified embodiment with the two USB channels and no programmable interface.

FIG. 3 is a functional electronic block diagram showing another variation of a simplified embodiment of the apparatus, showing all the electronic programmable and non-programmable functional blocks that comprise the electronic part of such variation of the simplified embodiment with the two physically separate PS/2 channels and no programmable interface.

FIG. 4 is a mechanical diagram of the Apparatus illustrating the exterior of the Apparatus and its mechanical features and user controls.

### DETAILED DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the invention. One skilled in the relevant art will recognize, however, that the invention may or may not be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Introduction

The invention—the hand-held pistol-grip dual functionality keyboard-mouse hybrid emulator, referred to hereafter as “the Apparatus”, comprises a device, method, and article of manufacture to be used as the input device with a desktop computer, a laptop computer, a mobile device, and in general, to be used with any computer technology, where the regular two-handed PS/2 or USB or wireless keyboard and the regular PS/2 or USB or wireless mouse are or may be used. Any such applicable computer technology will be referred to hereafter as “the computer” or “the host computer”. Furthermore, any regular modern computer keyboard and any regular modern computer mouse may be referred to hereafter as “standard keyboard” and “standard mouse” or “regular keyboard” and “regular mouse” respectively. The Apparatus is a hand-held device, designed and manufactured specifically for the one-handed operation. It must have a pistol-like handle in order to be operated as intended—hence the reference to the pistol grip.

The Apparatus has three modes of operation: the Main Keyboard Mode, the CAP Keyboard Mode, and the Mouse Mode. A separate button described below controls the mode switching.

In both keyboard modes the user is holding the pistol-grip handle in one hand and is alternately pressing “dash” and “dot” buttons located on the handle with his/her thumb and the index finger, thereby generating the Morse code, or any other suitable binary code. (This description concerns itself only with the usage of the International Morse Code, albeit modified, and its described extension, in conjunction with the Apparatus, referred to hereafter as “the Morse code”). The Apparatus then parses and converts the Morse codes to the Scan Codes using lookup table, then encodes the resulting Scan Codes to the PS/2 or USB or wireless format and transmits it to the host computer via the single connecting USB cable (or the dual PS/2 cable) or a suitable wireless connection (e.g. Blue Tooth), where the existing keyboard and mouse (PS/2 or USB or wireless) device drivers are used to process the signals from and to the Apparatus as if they were the regular PS/2 or USB or wireless keyboard and mouse signals. It can be said, that the Apparatus, in fact, emulates both, the regular PS/2 or USB or wireless keyboard and mouse in a single hand-held and ore-hand-operated device.

In both keyboard modes the Apparatus operates in the same way, except that the CAP Keyboard Mode switches the Apparatus to the Upper Case letters.

In the Mouse Mode, from the computer standpoint the Apparatus operates as a regular computer mouse. The detailed description of the Apparatus operation follows in the paragraphs below.

The advantages of the Apparatus as compared to the existing separate keyboard and mouse technologies are, but not limited to:
The Apparatus is operated entirely and completely with one hand (either left or right one).
Fast typing ability. An average professional typist reaches 50 to 70 words per minute on the regular two-handed keyboard. A proficient Morse code user can send in excess of 60 words per minute. The speed of 15-30 words per minute is fairly typical. (A “word” is counted as five ASCII characters in a raw).
The Morse code is easy to learn and can quickly become a “second nature” and a “second language”. Attaining proficiency in the Morse code is just a matter of using it regularly, and may be a fun thing to do.
No change in the functionality, i.e. the Apparatus emulates both the keyboard and mouse in the single hand-held device.
Portability—the Apparatus is a hand-held device, so obviously it is easily portable. It can be connected to the host computer and used anywhere the user goes.
Flexibility. The Apparatus is just as useful when connected to any size computer—from the desktop computer to a Blackberry sized mobile device.
Ability to type not looking at the keyboard—i.e. there is no keyboard to look at, which saves time and increases productivity.
Ability to type in poor lighting conditions or even in complete darkness. This is particularly useful when exchanging text messages in dimly lit places.
Ability to operate the Apparatus in any position—sitting, standing, lying down, reclining.
Ability to type text and send emails and text messages with one hand.
Ability to switch between the keyboard and mouse functionality fast—just with the thumb of one hand—and without changing position—i.e. no need to move the hand between the mouse and the keyboard, which saves time and increases productivity.
The Apparatus saves space—no additional space on the desk or table required for the keyboard and mouse—and that without sacrificing the functionality of the regular keyboard and mouse.
The Apparatus is particularly beneficial for people with the disability in one hand. If such a person has to spend significant amount of time on the computer, the Apparatus will help him/her to become as productive as a person with no disability.

Technical Details

The Apparatus described herein combines significant portion if not all the functionalities and can serve as a very capable replacement of simultaneously both the regular two-handed QWERTY computer keyboard and the regular computer mouse, combined in one single hand-held and one-handed device. This is due to the fact that the Apparatus covers fairly complete set of the ASCII characters and the keyboard keys, as well as the entire mouse functionality. The Apparatus is designed and manufactured specifically for one-handed operation.

The Apparatus embodies the following mechanical and electronic operational features:

1. The mechanical construction of the Apparatus is comprised of the pistol-grip handle—looking much like the handle of a pistol—and the four mechanical controls on top of it, operated by the user's index finger and the thumb. These four controls are: a) The trigger (for the index finger), located where the trigger is normally located relative to the handle—just like the pistol trigger; b) The thumb button, located close to the top of the handle and to the left (to the right for the left-handed user), where the thumb can conveniently and comfortably operate the thumb button. The thumb button is positioned on the protruding thumb rest, so that the thumb always presses down, in normal and comfortable fashion; c) The trackball—located at the top of the handle, where the thumb can conveniently and comfortably reach it and rotate the trackball in order to move the arrow or cursor on the computer screen; d) The mode-switch button, located just in front of the trackball and below it, on top of the handle, where the thumb can conveniently reach the mode-switch button such that the mode-switch button does not obstruct the operation of the trackball. The trackball is supported from inside by a light spring, that keeps it pressed against the perimeter of the trackball access opening, to keep it fixed in position and to avoid wobbliness.

2. The electronic construction of the Apparatus is comprised of all the electronic parts of the Apparatus that reside on the Printed Circuit Board hidden inside the pistol-grip handle of the Apparatus and the Printed Circuit Board itself. In case of the wire-line connection with the host computer, there is also the USB or the dual PS/2 connecting cable for the connection to the host computer. The Apparatus may require a battery or a power supply depending on the type of the USB port on the host computer. No power supply or battery required in case of the dual PS/2 cable—the PS/2 port always provides the powering voltage.

3. The Apparatus has three modes of operation: the Main Keyboard Mode, the CAP Keyboard Mode, and the Mouse Mode. The difference between the two keyboard modes is that the CAP Keyboard Mode switches the Apparatus to the Upper Case letters. The mode-switch button controls the mode switching. The mode-switch button sole function is to do the “hard” toggle between the three modes. The thumb operates the mode-switch button.

4. In both keyboard modes of operation the user is holding the pistol-grip handle of the apparatus, and by pressing alternately the trigger and the thumb button generates the Morse code i.e. “dots” and “dashes”. The Morse code thus generated is parsed to Scan Codes and then converted by the Apparatus to the PS/2 or USB or wireless format and then transmitted to the host computer via the single connecting USB cable (or the dual PS/2 cable) or a suitable wireless connection (e.g. Blue Tooth), where the existing keyboard and mouse device drivers are used to process the signals from and to the Apparatus as if they were regular PS/2 or USB or wireless keyboard and mouse signals. It can be said, that the Apparatus, in fact, emulates the regular PS/2 or USB or wireless keyboard and mouse.

5. In the Mouse Mode the thumb button and the trigger become the “left” and the “right” mouse buttons respectively (the “left” and “right” are defined herein with respect to the right-handed user operating the regular computer mouse). The user then operates the Apparatus as the regular mouse, albeit holding it in one hand, by the pistol-grip handle. The user is also using his/her thumb to rotate the trackball. In the Mouse Mode the Apparatus operates exactly as the regular mouse by pressing the thumb button (for the left mouse), pulling the trigger (for the right mouse), and rotating the trackball with the thumb to move the arrow or the cursor on the screen. There are, however, some important mechanical differences described below. It must be stressed, however, that no change to any standard mouse driver is required on the host-computer side, as the result. The mechanical differences described below are accommodated by the Mouse & Dash-Dot to PS/2 Encoder Router & Host Command Processor. So, from the host-computer standpoint, in the Mouse Mode, the Apparatus operates exactly as the regular mouse, i.e. emulates the regular computer mouse.

6. The Mouse shortcuts, in the Mouse Mode, such as the highlighting, copying, and cutting the text as well as the drugging and dropping drug-able objects exist as well, but to implement these, the modifications dictated by the mechanical design of the Apparatus must be made. Therefore, the standard “hold-down-left-mouse” and “un-hold-down-left-mouse” operations must be implemented differently. In this preferred embodiment they are replaced with the following two “start” and “end” operations: To start—“hold-down-the-thumb-button-click-trigger-then-release-all”; To end—the repeated “hold-down-the-thumb-button-click-trigger-then-release-all” operations, respectively, for the initiating, and completing/exiting a sub-mode, depending on the application context: a) the sub-mode of highlighting-and-copying the text or b) the sub-mode of grabbing-and-dragging and then dropping a drug-able object or c) the sub-mode of highlighting-and-cutting the text—for this sub-mode the repeated “hold-down-the-thumb-button-click-trigger-then-release-all” operation is replaced with “hold-down-the-thumb-button-double-click-trigger-then-release-all” operation.

The operations between the initiation and exiting a sub-mode, if any, are always performed with the trackball, such as highlighting a portion of the text, or dragging a drug-able object.

Diagrammatically this looks as follows:
a) The sub-mode of highlighting-and-copying the text;
Set the cursor at the beginning (end) of the text with the trackball, as usual→“hold-down-the-thumb-button-click-trigger-then-release-all”→move the trackball with the thumb to highlight the text→repeat “hold-down-the-thumb-button-click-trigger-then-release-all” to copy the text and exit the sub-mode.
b) The sub-mode of grabbing-and-dragging and then dropping a drug-able object;
Point to the object with the arrow with the trackball, as usual→“hold-down-the-thumb-button-click-trigger-then-release-all” to grab the object→move the trackball with the thumb to drug the object→repeat “hold-down-the-thumb-button-click-trigger-then-release-all” to drop the object and exit the sub-mode.
c) The sub-mode of highlighting-and-cutting the text;
Set the cursor at the beginning (end) of the text with the trackball, as usual→“hold-down-the-thumb-button-click-trigger-then-release-all”→move the trackball with the thumb to highlight the text→“hold-down-the-thumb-button-double-click-trigger-then-release-all” to cut the text and exit the sub-mode.
   There is no shortcut for the pasting the text in the Mouse Mode—just as with the regular mouse, the user has to use the trigger (the left mouse) to bring up the menu and then to paste the text via the menu option “paste”. However the user may be able to use a custom-programmed Morse code (by assigning it to the Control-V keyboard combination), in order to implement text pasting in the keyboard modes.

7. The following 5 LED indicators are located on the pistol-grip handle, such that they could be easily seen, have the following coloring scheme: Green LED on—Device Ready; Red LED on—Device not ready; Yellow LED on—Device is in the Mouse Mode; Blue LED on—Device is in the CAP Keyboard mode; Orange LED on—Device is in the Main Keyboard mode.

The Functional Diagram of the Apparatus

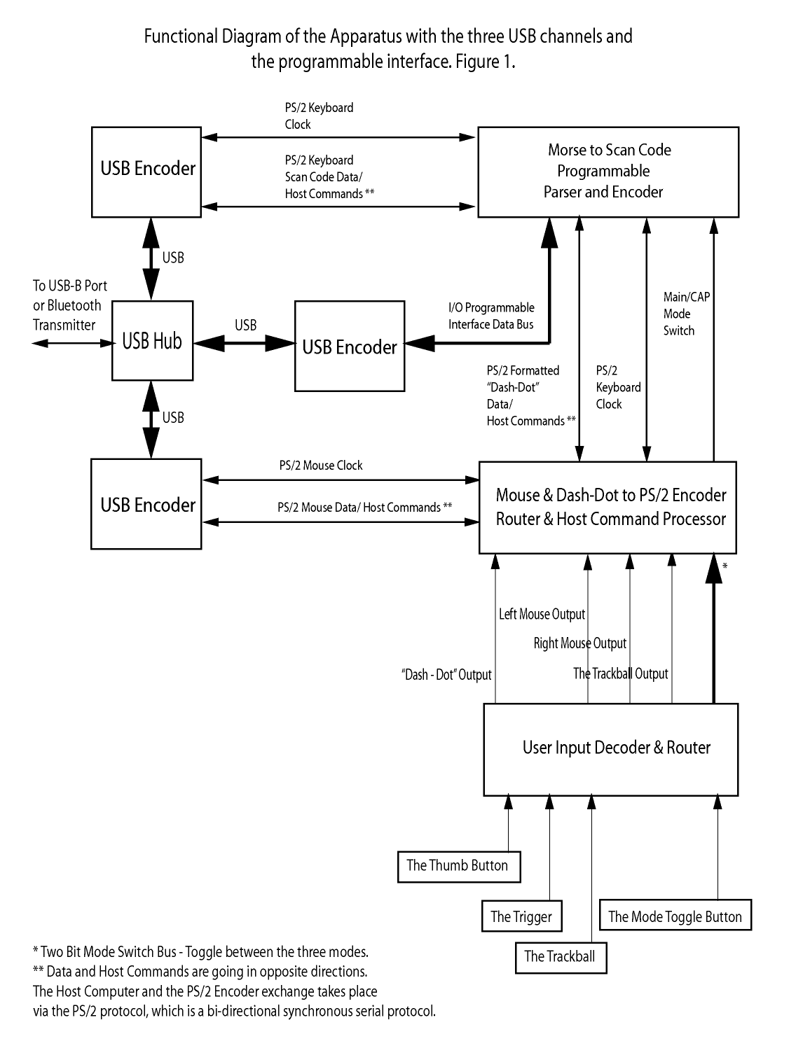

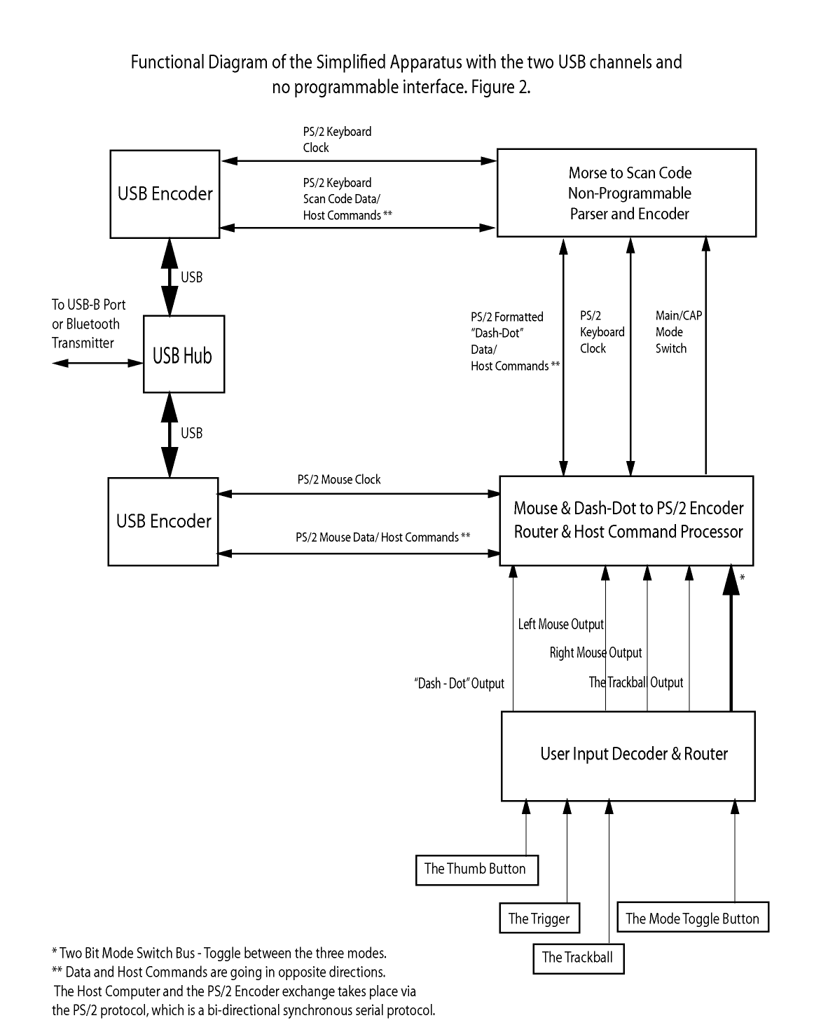

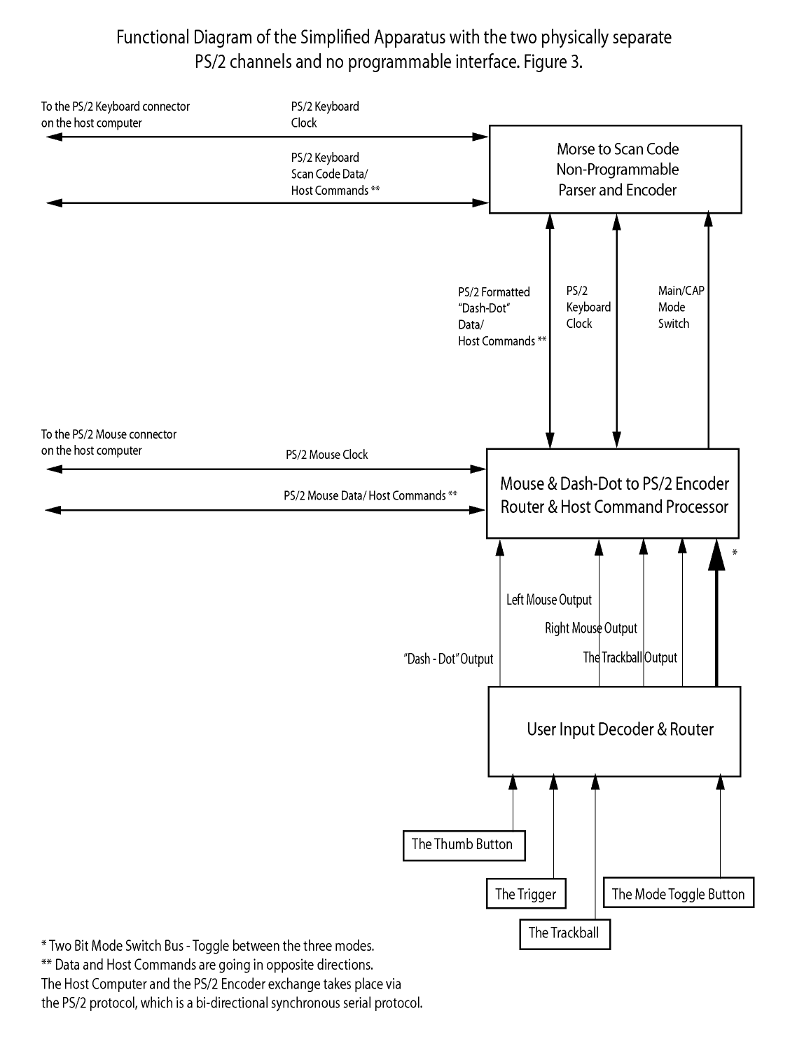

The functional diagram of the Apparatus is represented in the FIG. 1. The diagram represents the USB version of the Apparatus with the maximum possible functionality i.e. the three USB channels and the USB Hub, as well as the Morse to Scan Code Programmable Parser and Encoder on board. The separate USB channel is provided for the user to modify, in a limited way, the factory default settings of the Morse to Scan Code Programmable Parser and Encoder, from the host computer, to the users own Morse code settings. The device driver must also be installed on the host computer, to communicate with the Apparatus Programmable Interface. The Apparatus could be simplified in the following ways:
a) FIG. 2. In this simplified USB version of the Apparatus, the separate USB channel to program the Morse to Scan Code Parser and Encoder could be removed, when using the design with the Non-Programmable Morse to Scan Code Parser and Encoder. In that case the Morse to Scan Code Parser and Encoder is factory programmed or is an ASIC (Application Specific Integrated Circuit). The user does not have an option of modifying the factory settings. The apparatus may or may not require a power supply or a battery, depending on the type of the USB port on the host computer. The Apparatus does not require the installation of any device driver on the host computer—assuming the USB regular keyboard and mouse drivers are present.
b) FIG. 3. In this simplified non-USB version of the Apparatus, all the USB functionality is removed, thereby making the Apparatus equivalent to the PS/2 keyboard and the PS/2 mouse combined in one device. In that case the Morse to Scan Code Parser and Encoder is factory programmed or is an ASIC (Application Specific Integrated Circuit). The user does not have an option of modifying the factory settings. The Apparatus also requires the dual PS/2 connecting cable to the host computer—one for the keyboard path and another one for the mouse path. No power supply or battery required—the PS/2 port always supplies the powering voltage. The Apparatus does not require the installation of any device driver on the host computer—assuming the PS/2 regular keyboard and mouse drivers are present.

The Apparatus depicted in the Figures herein functions as follows. Upon the power-up the Apparatus is first brought into the default mode—the Mouse Mode. The appearance of the LED green light on the pistol-grip handle indicates the Apparatus is ready. At that point the user operates the Apparatus as a regular mouse. The user may then open a word-processing application i.e. Microsoft Word or any other application. In the Mouse Mode, the User Input Decoder & Router takes the user inputs from the Thumb button, the Trigger, and the Trackball, and routes the three corresponding mouse signals to the Mouse & Dash-Dot to PS/2 Encoder Router & Host Command Processor via the Left Mouse output, the Right Mouse output, and the Trackball output. The Mouse & Dash-Dot to PS/2 Encoder Router & Host Command Processor then encodes the mouse signals into the PS/2 format and routes them to the USB encoder, which in turn routes the signals to the USB Hub. At that point the USB mouse signal is output to the USB-B port or serves as an input to the Blue Tooth transmitter.

Switching to a keyboard mode at an arbitrary point in the computer session does nothing aside from blocking the operation of the mouse. To turn the mouse back on the user must toggle the Mode Switch button to bring the Apparatus back to the Mouse Mode.

When in the word-processing application (the arrow turns into the cursor), the user may wish to switch to one of the two keyboard modes with the Mode Switch button, to enter the text. After the switch, the mouse operation is blocked and the user can only operate the Thumb button and the Trigger as dash and dot generators.

When in any one of the two keyboard modes, the User Input Decoder & Router takes the user inputs from the Thumb button, and the Trigger, converts them to digital “dashes” and “dots”, serializes them, and routes the resulting signal to the Mouse & Dash-Dot to PS/2 Encoder Router & Host Command Processor via the Dash-Dot output. The Mouse & Dash-Dot to PS/2 Encoder Router & Host Command Processor then encodes the Dash-Dot signal into the PS/2 format and routes them to the Morse To Scan Code Parser and Encoder. The Morse To Scan Code Parser and Encoder then parses the Dash-Dot signal into the Morse code combinations, and associates a Morse code combination of dashes and dots with a Scan Code using the internal lookup table(s). The Morse To Scan Code Parser and Encoder then routes the Scan code to the USB encoder.

The Principles of Operation of the Morse To Scan Code Parser and Encoder

The dots and dashes come into the Morse To Scan Code Parser and Encoder (“The Parser”) as a serial stream, in the form of bytes of data, without the markers indicating the beginning and the end of the Morse code combination. So, the identification of the Morse code combination by the Parser takes place in the synchronous fashion. That means that at the power-up the Parser is brought into a known state waiting for the user input. At that point the Parser starts looking for a valid Morse code within a certain, factory default-programmed (or subsequently user modified) time slot. As soon as, within the allotted time slot, the Parser identifies a valid Morse code combination, it decodes the combination and sends out the corresponding Scan code. In case the Parser does not make the identification of the valid Morse code combination, the Parser discards the data and continues to wait for the new portion of dots and dashes. Therefore, the successful transmission of the Morse code combination requires the user to make time intervals between the Morse combinations, as to allow the Parser an opportunity to correctly decode the combination. This is in line with the Morse code principles of operation and the user should understand and learn how to correctly transmit the Morse code. This does take some practice, however, can be fairly easily achieved by an average person. The allotted time slot, within which the Parser waits for the user input can be made programmable. As the user gains proficiency with the Morse code, and the Morse transmission speed increases, the allotted time slot can be reprogrammed, i.e. shortened. Alternatively, if the user finds the reprogrammed time slot is too short, the user can increase the duration of the slot.

One more negative possibility is the incorrect decoding i.e. the Parser outputting not what the user intended—the wrong symbol. This has to do with either the user not yet achieving sufficient skill in transmitting the Morse code, or just an occasional error. This is equivalent to the user of the regular keyboard hitting the wrong key.

The Morse Code to Scan Code Mapping and Programmability

The Morse To Scan Code Parser and Encoder inside the Apparatus uses a lookup table to convert the Morse code into the Scan Codes. The default lookup table using the Scan Code Set 2 is represented in the TABLE 1. The Scan Code Set 2 represents the most common set used by the modern PS/2 keyboards. However, the Scan Code sets may differ depending on the technology used. For example, the USB keyboards use different Scan Code set described in the USB standard. It is up to the manufacturer to decide which Scan Code set to use for one-to-one mapping between the keyboard keys and the scan codes.

This application concerns itself with the preferred embodiment of the mapping between the Morse code and the keyboard keys, and that preferred embodiment is reflected in the first four columns of the TABLE 1.

This application also concerns itself with the method in conjunction with the Apparatus, whereby the association is made between the Morse code, the keyboard character (key) and the Scan Code.

For the programmable version of the Apparatus, in FIG. 1 the user has the option of modifying the default settings in the TABLE 1, which means the user is able to assign any valid Scan Code (i.e. any valid combination of the keyboard keys—or “composite keys”) to any Morse code combination of dots and dashes, provided that the Morse code combination the user wishes to assign to is the unique one in the lookup TABLE 1. The commercial software that the manufacturer may include with the Apparatus will do all necessary validity checks on the composite keys before allowing the user to proceed with the assignment. The user may also have the option to expand the TABLE 1 albeit in a limited fashion determined by the manufacturer—thereby creating the new Morse code entries, for new combinations of the keyboard keys (composite keys). The commercial software included with the Apparatus will not require the user to know the Scan codes—it will only ask for one parameter: the Morse code combination to be assigned to. The software will then offer to the user the list of the valid composite keys to choose from for the assignment. It is not recommended for the manufacturer to allow the user to assign an arbitrary composite key to a Morse code combination, to avoid sending arbitrary signals that may damage the computer.

As described above, one more important programmable parameter is the time slot within which the Apparatus (or The Parser to be exact) is waiting for the user to finish entering the Morse code combination before locking the combination and attempting to decode it.

The Manner and Process of Making the Invention

The apparatus requires two major types of components in order to be properly manufactured: mechanical and electronic. The mechanical components are comprised of the plastic pistol-grip handle and the controls. The electronic components are the Printed Circuit Board that is contained inside the plastic pistol-grip handle and all the electronic parts on it. Therefore, any company that engages in the manufacturing of consumer electronics can easily manufacture the Apparatus.

TABLE 1
The Default Morse-To-Character-To-Scan-Code Lookup Table used by the
Morse-To-Scan-Code Parser and Encoder using the Scan Code Set 2.

| | | | | Scan Code Set 2 | |
|---|---|---|---|---|---|
| | | | | Make Code; Break Code | |
| | Morse | Key | | Main Mode | CAP Mode |
| Sequence | Code | Index | Character | Make; Break | Make; Break |
| 1 | * | 19 | e | 24h; F0h, 24h | 12h, 24h; F0h, |
| | | | | | 24h, F0h, 12h |
| 2 | - | 21 | t | 2Ch; F0h, 2Ch | 12h, 2Ch; F0h, |
| | | | | | 2Ch, F0h, 12h |
| 3 | ** | 24 | i | 43h; F0h, 43h | 12h, 43h; F0h, |
| | | | | | 43h, F0h, 12h |
| 4 | -* | 51 | n | 31h; F0h, 31h | 12h, 31h; F0h, |
| | | | | | 31h F0h, 12h |
| 5 | *- | 31 | a | 1Ch; F0h, 1Ch | 12h, 1Ch; F0h, |
| | | | | | 1Ch, F0h, 12h |
| 6 | -- | 52 | m | 3Ah; F0h, 3Ah | 12h, 3Ah; F0h, |
| | | | | | 3Ah, F0h, 12h |
| 7 | *** | 32 | s | 1Bh; F0h, 1Bh | 12h, 1Bh; F0h, |
| | | | | | 1Bh, F0h, 12h |
| 8 | -** | 33 | d | 23h; F0h, 23h | 12h, 23h; F0h, |
| | | | | | 23h, F0h, 12h |
| 9 | *-* | 20 | r | 2Dh; F0h, 2Dh | 12h, 2Dh; F0h, |
| | | | | | 2Dh, F0h, 12h |
| 10 | --* | 35 | g | 34h; F0h, 34h | 12h, 34h; F0h, |
| | | | | | 34h, F0h, 12h |
| 11 | **- | 23 | u | 3Ch; F0h, 3Ch | 12h, 3Ch; F0h, |
| | | | | | 3Ch, F0h, 12h |
| 12 | -*- | 38 | k | 42h; F0h, 42h | 12h, 42h; F0h, |
| | | | | | 42h, F0h, 12h |
| 13 | *-- | 18 | w | 1Dh; F0h, 1Dh | 12h, 1Dh; F0h, |
| | | | | | 1Dh, F0h, 12h |
| 14 | --- | 25 | o | 44h; F0h, 44h | 12h, 44h; F0h, |
| | | | | | 44h, F0h, 12h |
| 15 | **** | 36 | h | 33h; F0h, 33h | 12h, 33h; F0h, |
| | | | | | 33h, F0h, 12h |
| 16 | -*** | 50 | b | 32h; F0h, 32h | 12h, 32h; F0h, |
| | | | | | 32h, F0h, 12h |
| 17 | *-** | 39 | l | 4Bh; F0h, 4Bh | 12h, 4Bh; F0h, |
| | | | | | 4Bh, F0h, 12h |
| 18 | --** | 46 | z | 1Ah; F0h, 1Ah | 12h, 1Ah; F0h, |
| | | | | | 1Ah, F0h, 12h |
| 19 | **-* | 34 | f | 2Bh; F0h, 2Bh | 12h, 2Bh; F0h, |
| | | | | | 2Bh, F0h, 12h |
| 20 | -*-* | 48 | c | 21h; F0h, 21h | 12h, 21h; F0h, |
| | | | | | 21h, F0h, 12h |
| 21 | *--* | 26 | p | 4Dh; F0h, 4Dh | 12h, 4Dh; F0h, |
| | | | | | 4Dh, F0h, 12h |
| 22 | ---* | 12 | - | 4Eh; F0h, 4Eh | Same as Main Mode. |
| 23 | ***- | 49 | v | 2Ah; F0h, 2Ah | 12h, 2Ah; F0h, |
| | | | | | 2Ah, F0h, 12h |
| 24 | -**- | 47 | x | 22h; F0h, 22h | 12h, 22h; F0h, |
| | | | | | 22h, F0h, 12h |
| 25 | *-*- | 43 | <Enter> | 5A; F0h, 5Ah | Same as Main Mode. |
| 26 | --*- | 17 | q | 15h; F0h, 15h | 12h, 15h; F0h, |
| | | | | | 15h, F0h, 12h |
| 27 | **-- | 61 | <Space> | 29h; F0h, 29h | Same as Main Mode. |
| 28 | -*-- | 22 | y | 35h; F0h, 35h | 12h, 35h; F0h, |
| | | | | | 35h, F0h, 12h |
| 29 | *--- | 37 | j | 3Bh; F0h, 3Bh | 12h, 3Bh; F0h, |
| | | | | | 3Bh, F0h, 12h |
| 30 | ---- | 15 | <Backspace> | 66h; F0h, 66h | Same as Main Mode. |
| 31 | ***** | 6 | 5 | 2Eh; F0h, 2Eh | Same as Main Mode. |
| 32 | -**** | 7 | 6 | 36h; F0h, 36h | Same as Main Mode. |
| 33 | *-*** | Shift 9 | * | 12h, 3Eh; F0h, | Same as Main Mode. |
| | | | | 3Eh, F0h, 12h | |
| 34 | --*** | 8 | 7 | 3Dh; F0h, 3Dh | Same as Main Mode. |
| 35 | **-** | 110 | <Esc> | 76h; F0h, 76h | Same as Main Mode. |
| 36 | -*-** | 81 | <End> | E0h, 69h; | Same as Main Mode. |
| | | | | E0h, F0h, 69h | |
| 37 | *--** | Shift 13 | + | 12h, 55h; F0h, | Same as Main Mode. |
| | | | | 55h, F0h, 12h | |
| 38 | ---** | 9 | 8 | 3Eh; F0h, 3Eh | Same as Main Mode. |
| 39 | ***-* | 40 | ; | 4Ch; F0h, 4Ch | Same as Main Mode. |
| 40 | -**-* | 76 | <Del> | E0h, 71h; | Same as Main Mode. |
| | | | | E0h, F0h, 71h | |
| 41 | *-*-* | | | | Mouse Mode Switch |
| 42 | --*-* | | | | CAP Mode Switch |
| 43 | **--* | Shift 12 | <Underline> | 12h, 4Eh; F0h, | Same as Main Mode. |
| | | | | 4Eh, F0h, 12h | |
| 44 | -*--* | 16 | <Tab> | 0Dh; F0h, 0Dh | Same as Main Mode. |
| 45 | *---* | Shift 3 | @ | 12h, 1Eh; F0h, | Same as Main Mode. |
| | | | | 1Eh, F0h, 12h | |
| 46 | ----* | 10 | 9 | 46h; F0h, 46h | Same as Main Mode. |
| 47 | ****- | 5 | 4 | 25h; F0h, 25h | Same as Main Mode. |
| 48 | -***- | | | | Main Mode Switch |
| 49 | *-**- | 75 | <Insert> | E0h, 70h; | Same as Main Mode. |
| | | | | E0h, F0h, 70h | |
| 50 | --**- | 55 | / | 4Ah; F0h, 4Ah | Same as Main Mode. |
| 51 | **-*- | 44 | <Left shift> | 12h; F0h, 12h | Same as Main Mode. |
| 52 | -*-*- | 58 | <Left ctrl> | 14h; F0h, 14h | Same as Main Mode. |
| 53 | *--*- | 13 | = | 55h; F0h, 55h | Same as Main Mode. |
| 54 | ---*- | | | | Reserved. |
| 55 | ***-- | 4 | 3 | 26h; F0h, 26h | Same as Main Mode. |
| 56 | -**-- | Shift 8 | & | 12h, 3Dh; F0h, | Same as Main Mode. |
| | | | | 3Dh, F0h, 12h | |
| 57 | *-*-- | 60 | <Left alt> | 11h; F0h, 11h | Same as Main Mode. |
| 58 | --*-- | Shift 41 | “ | 12h, 52h; F0h, | Same as Main Mode. |
| | | | | 52h, F0h, 12h | |
| 59 | **--- | 3 | 2 | 1Eh; F0h, 1Eh | Same as Main Mode. |
| 60 | -*--- | Shift 4 | # | 12h, 26h; F0h, | Same as Main Mode. |
| | | | | 26h, F0h, 12h | |
| 61 | *---- | 2 | 1 | 16h; F0h, 16h | Same as Main Mode. |
| 62 | ----- | 11 | 0 | 45h; F0h, 45h | Same as Main Mode. |
| 63 | ****** | 116 | F5 | 03h; F0h, 03h | Same as Main Mode. |
| 64 | -***** | 29 | \ | 5Dh; F0h, 5Dh | Same as Main Mode. |
| 65 | *-**** | 117 | F6 | 0Bh; F0h, 0Bh | Same as Main Mode. |
| 66 | --**** | | | | Reserved. |
| 67 | **-*** | 27 | [ | 54h; F0h, 54h | Same as Main Mode. |
| 68 | -*-*** | 28 | ] | 5Bh; F0h, 5Bh | Same as Main Mode. |
| 69 | *--*** | 118 | F7 | 83h; F0h, 83h | Same as Main Mode. |
| 70 | ---*** | 126 | <Break> | | Not used. |
| 71 | ***-** | Shift 29 | \| | 12h, 5Dh; F0h, | Same as Main Mode. |
| | | | | 5Dh, F0h, 12h | |
| 72 | -**-** | 118 | <Num lock> | 77h; F0h, 77h | Same as Main Mode. |
| 73 | *-*-** | | | | Reserved. |
| 74 | --*-** | | | | Reserved. |
| 75 | **--** | Shift 55 | ? | 12h, 4Ah; F0h, | Same as Main Mode. |
| | | | | 4Ah, F0h, 12h | |
| 76 | -*--** | | | | Reserved. |
| 77 | *---** | 119 | F8 | 0Ah; F0h, 0Ah | Same as Main Mode. |
| 78 | ----** | 83 | <Up arrow> | E0h, 75h; | Same as Main Mode. |
| | | | | E0h, F0h, 75h | |
| 79 | ****-* | 80 | <Home> | E0h, 6Ch; | Same as Main Mode. |
| | | | | E0h, F0h, 6Ch | |
| 80 | -***-* | Shift 5 | $ | 12h, 25h; F0h, | Same as Main Mode. |
| | | | | 25h, F0h, 12h | |
| 81 | *-**-* | | | | Reserved. |
| 82 | --**-* | Shift 54 | > | 12h, 49h; F0h, | Same as Main Mode. |
| | | | | 49h, F0h, 12h | |
| 83 | **-*-* | 30 | <Caps lock> | 58h; F0h, 58h | Same as Main Mode. |
| 84 | -*-*-* | Shift 41 | : | 12h, 4Ch; F0h, | Same as Main Mode. |
| | | | | 4Ch, F0h, 12h | |
| 85 | *--*-* | Shift 6 | % | 12h, 2Eh; F0h, | Same as Main Mode. |
| | | | | 2Eh, F0h, 12h | |
| 86 | ---*-* | 86 | <Page down> | E0h, 7Ah; | Same as Main Mode. |
| | | | | E0h, F0h, 7Ah | |
| 87 | ***--* | Shift 10 | ( | 12h, 46h; F0h, | Same as Main Mode. |
| | | | | 46h, F0h, 12h | |
| 88 | -**--* | Shift 11 | ) | 12h, 45h; F0h, | Same as Main Mode. |
| | | | | 45h, F0h, 12h | |
| 89 | *-*--* | 41 | ' (Apostrophe) | 52h; F0h, 52h | Same as Main Mode. |
| 90 | --*--* | | | | Reserved. |
| 91 | **---* | Shift 27 | { | 12h, 54h; F0h, | Same as Main Mode. |
| | | | | 54h, F0h, 12h | |
| 92 | -*---* | Shift 28 | } | 12h, 5Bh; F0h, | Same as Main Mode. |
| | | | | 5Bh, F0h, 12h | |
| 93 | *----* | 120 | F9 | 01h; F0h, 01h | Same as Main Mode. |
| 94 | -----* | 89 | <Right arrow> | E0h 74h; | Same as Main Mode. |
| | | | | E0h, F0h, 74h | |
| 95 | *****- | 115 | F4 | 0Ch; F0h, 0Ch | Same as Main Mode. |
| 96 | -****- | Shift 124, | <Print screen> | E0h, 7Ch; | Same as Main Mode. |
| | | Ctrl 124 | | E0h, F0h, 7Ch | |
| 97 | *-***- | Shift 53 | < | 12h, 41h; F0h, | Same as Main Mode. |
| | | | | 41h, F0h, 12h | |
| 98 | --***- | Shift 1 | ~ | 12h, 0Eh; F0h, | Same as Main Mode. |
| | | | | 0Eh, F0h, 12h | |
| 99 | **-**- | 1 | \grave{ } | 0Eh; F0h, 0Eh | Same as Main Mode. |
| 100 | -*-**- | Shift 7 | \hat{ } | 12h, 36h; F0h, | Same as Main Mode. |
| | | | | 36h, F0h, 12h | |
| 101 | *--**- | Ctrl 126 | <Pause> | E0h, 7Eh, E0h, | Same as Main Mode. |
| | | | | F0h, 7E; none | |
| 102 | ---**- | 85 | <Page up> | E0h, 7Dh; | Same as Main Mode. |
| | | | | E0h, F0h, 7Dh | |
| 103 | ***-*- | 125 | <Scroll lock> | 7E; F0h, 7E | Same as Main Mode. |
| 104 | -**-*- | | | | Reserved. |
| 105 | *-*-*- | 54 | . (Period) | 49h; F0h, 49h | Same as Main Mode. |
| 106 | --*-*- | 64 | <Right ctrl> | E0h, 14h; | Same as Main Mode. |
| | | | | E0h, F0h, 14h | |
| 107 | **--*- | 62 | <Right alt> | E0h, 11h; | Same as Main Mode. |
| | | | | E0h, F0h, 11h | |
| 108 | -*--*- | 124 | <Sys rq> | | Not used. |
| 109 | *---*- | 57 | <Right shift> | 59h; F0h, 59h | Same as Main Mode. |
| 110 | ----*- | 79 | <Left arrow> | E0h, 6Bh; | Same as Main Mode. |
| | | | | E0h, F0h, 6Bh | |
| 111 | ****-- | 114 | F3 | 04h; F0h, 04h | Same as Main Mode. |
| 112 | -***-- | | | | Reserved. |
| 113 | *-**-- | Shift 2 | ! | 12h, 16h; F0h, | Same as Main Mode. |
| | | | | 16h, F0h, 12h | |
| 114 | --**-- | 53 | , (Comma) | 41h; F0h, 41h | Same as Main Mode. |
| 115 | **-*-- | | | | Reserved. |
| 116 | -*-*-- | | | | Reserved. |
| 117 | *--*-- | 42 | <International | 5Dh; F0h, 5Dh | Same as Main Mode. |
| | | | key 42> | | Available on |
| | | | | | International |
| | | | | | keyboards only. |
| 118 | ---*-- | 45 | <International | 61h; F0h, 61h | Same as Main Mode. |
| | | | key 45> | | Available on |
| | | | | | International |
| | | | | | keyboards only. |
| 119 | ***--- | 113 | F2 | 06h; F0h, 06h | Same as Main Mode. |
| 120 | -**--- | 123 | F12 | 07h; F0h, 07h | Same as Main Mode. |
| 121 | *-*--- | | | | Reserved. |
| 122 | --*--- | | | | Reserved. |
| 123 | **---- | 112 | F1 | 05h; F0h, 05h | Same as Main Mode. |
| 124 | -*---- | 122 | F11 | 78h; F0h, 78h | Same as Main Mode. |
| 125 | *----- | 121 | F10 | 09h; F0h, 09h | Same as Main Mode. |
| 126 | ------ | 84 | <Down arrow> | E0h, 72h; | Same as Main Mode. |
| | | | | E0h, F0h, 72h | |

It will be appreciated that, although specific embodiment of the invention (the Apparatus) have been described herein for purposes of illustration, various modifications may be made without departing from the spirit and scope of the invention. In particular, the pistol-grip handle may come in different forms and sizes, as well as the mechanical controls. The electronic hardware design and the schematic of the Apparatus could very, reflecting particulars implementation variations. The Apparatus could be programmable or non-programmable. The default mappings between the Morse codes, the keyboard keys and the Scan codes (Scan code sets) could vary. Accordingly, the scope of the protection of this invention is limited only by the following claims and their equivalents.

I claim:

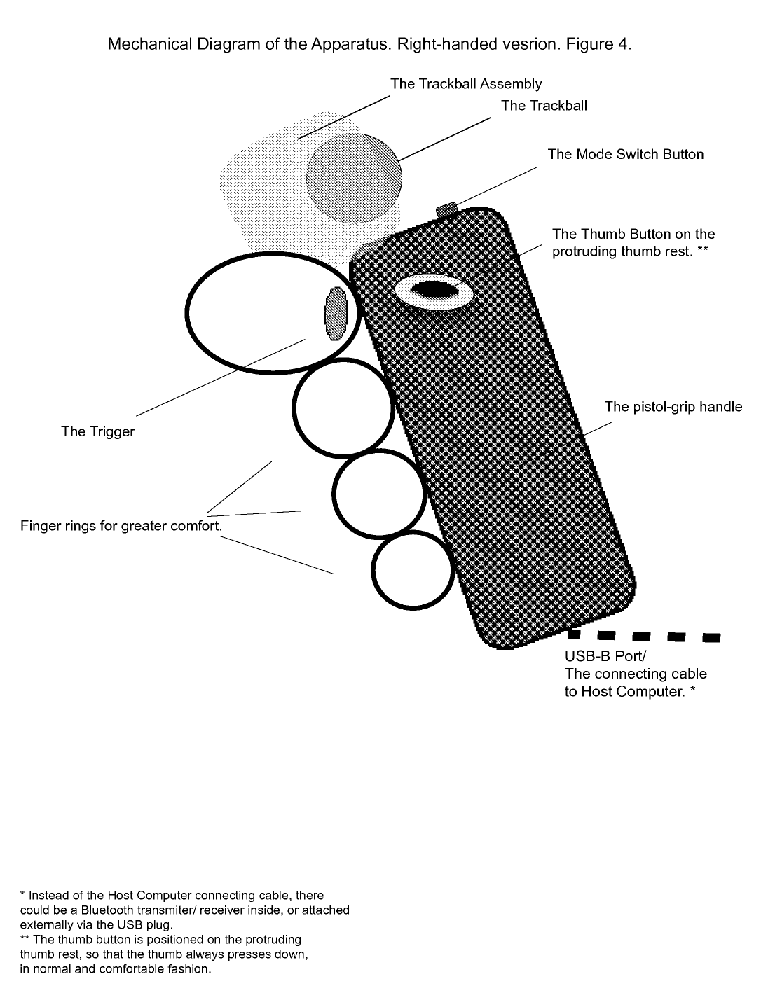

1. A hand-held, one-hand-operated computer input device, using the dual PS/2 cable or a single USB cable or a wireless connection to the host computer, as described above in the specification, and mechanically comprising:
A pistol-grip handle, designed to be held with one hand, either the left or the right one—in the manner almost exactly similar to holding the handle of a pistol; the handle will or will not have the finger rings for an improved convenience of operation, as depicted in FIG. 4.
At least three mechanical controls, positioned close to the top of the handle, as described above in the specification and also depicted in FIG. 4, which are: the thumb button (which serves as the “left” mouse), the trigger (which serves as the “right” mouse) and the trackball; these three controls enable the implementation of the standalone hand-held mouse functionality; or these three controls may enable the implementation of the dual functionality in one single device: i.e. both the hand-held mouse functionality (in the Mouse mode) and the PS/2 or USB or wireless keyboard functionality (in the Main and CAP keyboard modes), with the standard keyboard keys meanings corresponding to the Morse code combinations, according to the principles described above in the specification and the TABLE 1.
Four or more mechanical controls, positioned close to the top of the handle as described above in the specification and also depicted in FIG. 4, which are: the thumb button (i.e. the “left” mouse), the trigger (i.e. the “right” mouse), the trackball, and the mode switch button; these four or more controls enable the implementation of the dual functionality in one single device: i.e. both the hand-held mouse functionality (in the Mouse mode) and the PS/2 or USB or wireless keyboard functionality (in the Main and CAP keyboard modes), with the standard keyboard keys meanings corresponding to the Morse code combinations, according to the principles described above in the specification and the TABLE 1.

2. The device of the claim 1, electronically and/or programmatically comprising the following functional blocks:
As per FIG. 1:
A USB Hub;
Three USB encoders, corresponding to the three USB channels: the keyboard scan code channel, the mouse channel, and the programmable interface channel;
The Morse to Scan Code Programmable Parser and Encoder, which implements the method of the claim 3 and takes its inputs from The Mouse & Dash-Dot to PS/2 Encoder Router & Host Command Processor. Its primary function is to convert the inputs—which correspond to dash/dot combinations—into the corresponding keyboard scan codes, which are then transmitted to the host computer.
The Mouse & Dash-Dot to PS/2 Encoder Router & Host Command Processor, which converts its inputs from the User Input Decoder & Router into PS/2 protocol digital format and routs the corresponding digital signals to The Morse to Scan Code Programmable Parser and Encoder (in the Main or CAP modes) or directly to the mouse channel USB Encoder (in the Mouse mode). It also processes the PS/2 protocol commands from the host computer.
The User Input Decoder & Router, which converts the user inputs from the thumb button, the trigger, the trackball, and the mode switch button into the output signals, which then serve as inputs to the Mouse & Dash-Dot to PS/2 Encoder Router & Host Command Processor.
As per FIG. 2, the above description of this Claim applies except there are now two USB channels and correspondingly two USB encoders. The USB channel for the Apparatus programmable interface is removed.
As per FIG. 3, the above description of this Claim applies except there is no USB functionality. The Apparatus employs the PS/2 protocol only, and correspondingly there is the dual PS/2 cable connecting the Apparatus to the host computer—one PS/2 cable for the mouse channel and the other PS/2 cable for the keyboard channel. The channel for the programmable interface is removed.

3. The method in conjunction with the Apparatus of the claim 1, wherein the one-to-one correspondence is established between the Morse codes and the PS/2 or USB or wireless keyboard keys and the keyboard scan codes by means of a lookup table analogous to the TABLE 1; the method enables the Apparatus to use the Morse code in order to transmit the meanings of the standard PS/2 or USB or wireless keyboard keys to the host computer by determining the key scan code corresponding to a given Morse code, via a lookup table and then transmitting the scan code to the host computer. The method and the corresponding lookup table is implemented electronically and/or programmatically within the Morse to Scan Code Programmable Parser and Encoder or the Morse to Scan Code Non-Programmable Parser and Encoder as described above in the specification and depicted in the FIGS. 1, 2, and 3.

4. The method in conjunction with the Apparatus of the claim 1, wherein the “press-and-hold-and-drug” functionality for the highlighting the text or dragging a drag-able object, of the standard mouse (specifically the left mouse button) is implemented as described in the Item 6 in the paragraph “Technical Details” of the Specification.

5. The method in conjunction with the Apparatus of the claim 1, wherein the programmability of the Apparatus is provided via the programmable interface as depicted in FIG. 1: there is a separate dedicated USB channel which consists of the USB Hub and the USB Encoder. A programming protocol rides on top of the USB protocol in order to provide the bi-directional communication between the Apparatus (more specifically the Morse To Scan Code Programmable Parser and Encoder of the Apparatus) and the programming application running on the host computer. The USB Encoder interfaces to the Morse To Scan Code Programmable Parser and Encoder via the programmable interface bus. The programmable features include (but not limited to): reprogramming the default lookup TABLE 1, in such a way, as to assign a user-selected Morse combination to a keyboard key or allowed combination of keys; the duration of the time slot within which the Apparatus is waiting for the user to enter a Morse code combination, before it attempts to decode it.
